(19) United States
(12) Patent Application Publication
(10) Pub. No.: US 2023/0266017 A1
(43) Pub. Date: Aug. 24, 2023

(54) COOKING APPLIANCE HAVING A COOLING FAN DELAY FOR AN INTEGRATED GAS BURNER

(71) Applicant: Haier US Appliance Solutions, Inc., Wilmington, DE (US)

(72) Inventors: Justin Patrick Todd, Louisville, KY (US); Paul Kenneth Hengesbach, Louisville, KY (US)

(21) Appl. No.: 17/675,210

(22) Filed: Feb. 18, 2022

(51) Int. Cl. F24C 15/00; G05D 7/06; F24C 3/08

(52) U.S. Cl. CPC F24C 15/006; G05D 7/0676; F24C 3/085

(57) ABSTRACT

A cooking appliance is provided having a burner box, and integrated gas burner in fluid communication with the burner box, a cooking fan in communication with the burner box and the integrated gas burner, and a controller. The controller is in operative communication with the integrated gas burner and the cooking fan. The controller is configured to initiate a cooking operation. The cooking operation includes receiving a user activation request for the integrated gas burner, prompting activation of the integrated gas burner, directing limited-speed operation of the cooling fan over a predetermined time period, and directing, in response to expiration of the predetermined time period, increased-speed operation of the cooling fan.

### FIELD OF THE INVENTION

The present subject matter relates generally to cooking appliances, and more particularly to gas burners on cooking appliances.

### BACKGROUND OF THE INVENTION

Conventional cooking appliances, including conventional and commercial cooking appliances, may include a cabinet that defines a cooking chamber for receipt of food items for cooking and at least one burner attached to a top portion of the cabinet. In some cooking appliances, such as cooktop appliances, there is no cooking chamber, but burners sitting above a burner support setup. In gas powered cooking appliances, a burner box may be separate from the cooking chamber and may be above the cooking chamber. The burner box may allow for sufficient combustion air to be supplied to the burners attached to a top of the burner box, sometimes at the top portion of the cabinet. In some cooking appliances, a cooling fan may also be attached to the burner box to control temperatures and aid in general safety within the cooking appliance, including within the burner box, and may generally be turned on to regulate oven cooktop or burner box temperatures.

In some cases, such as when a gas burner is initially turned on, combustion air required to regulate the flame of the gas burner may be more difficult to draw into the gas burner to regulate the flame. Such difficulty may be magnified, such as in the case of an integrated gas burner or griddle, by features or functionality that reduce available combustion air (e.g., an active cooling fan) cooking appliance. In such cases, the flame of the gas burner may become erratic, growing to an unsafe level. Such effects may be increased when the gas burner is located within the burner box. Additionally, erratic flames as described above may be magnified at higher elevations, as air density generally decreases as elevation increases. When a gas burner comes to temperature (such as a user defined set temperature), it may be more able to draw sufficient combustion air.

Accordingly, a cooking appliance that aided a gas burner's ability to regulate flame levels would be desirable. In particular, it would be advantageous to have a cooking appliance that could regulate flame levels upon ignition when the cooking appliance is located at a high elevation.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a burner box, an integrated gas burner, a cooling fan, and a controller. The integrated gas burner may be in fluid communication with the burner box. The cooling fan may be in fluid communication with the burner box and the integrated gas burner. The controller may be in operative communication with the integrated gas burner and the cooling fan. The controller may be configured to initiate a cooking operation including receiving a user activation request for the integrated gas burner, prompting activation of the integrated gas burner in response to receiving the user activation request, directing, in response to prompting activation of the integrated gas burner, limited-speed operation of the cooling fan over a predetermined time period, and directing, in response to expiration of the predetermined time period, increased-speed operation of the cooling fan.

In another exemplary aspect of the present disclosure, a method of operating a cooking appliance is provided. The method may include the steps of receiving a user activation request for an integrated gas burner, prompting activation of the integrated gas burner in response to receiving the user activation request, directing, in response to prompting activation of the integrated gas burner, limited-speed operation of a cooling fan over a timer period, and directing, in response to expiration of the predetermined time period, increased-speed operation of the cooling fan. The cooling fan may be in fluid communication with a burner box. The burner box may be in fluid communication with the integrated gas burner. The cooling flan may be in fluid communication with the burner box and the integrated gas burner.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a cooking appliance of the present disclosure;

FIG. 2 provides a sectional plan view of the exemplary cooking appliance of FIG. 1;

FIG. 3 provides a cross-sectional, elevation view of a first airflow through the exemplary cooking appliance of FIG. 1;

FIG. 4 provides a cross-sectional, elevation view of a second airflow through the exemplary cooking appliance of FIG. 1;

FIG. 5 provides a cross-sectional, elevation view of a third airflow through the exemplary cooking appliance of FIG. 1; and

FIG. 6 provides a flow chart illustrating a method of exemplary embodiments of the present disclosure.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. Terms such as “inner” and “outer” refer to relative directions with respect to the interior and exterior of the cooking appliance, and in particular the chamber(s) defined therein. For example, “inner” or “inward” refers to the direction towards the interior of the cooking appliance. Terms such as “left,” “right,” “front,” “back,” “top,” or “bottom” are used with reference to the perspective of a user accessing the appliance (e.g., when the door is in the closed position). For example, a user stands in front of the appliance to open a door and reaches into the internal chamber(s) to access items therein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise, or counterclockwise, with the vertical direction V).

As used herein, the term “article” may refer to, but need not be limited to pots, pans, and other cooking utensils and items that can be placed on a cooking burner.

As will be described in better detail, embodiments include operations to reduce the potential for an integrated burner box to not receive an appropriate amount of primary or secondary combustion air. One method may include lowering a maximum cooling fan speed for a predetermined amount of time initiated with turning on the integrated gas burner. Another method may include halting cooling fan operation during a predetermined time period initiated with turning on the integrated gas burner. Advantageously, lowering the speed of the cooling fan or halting the cooling fan may aid in limiting flame runaway during initial an initial time period when turning on the integrated gas burner. Operation of integrated gas burners at high altitudes may be further improved by the methods and systems described herein.

As will be understood by those skilled in the art, cooking appliance 100 is provided by way of example only, and the present subject matter may be used in any suitable household appliance. Thus, the present subject matter may be used with other cooking appliances having different configurations, such as ranges, cooktops, etc. Cooking appliance 100 will be described below, with the understanding that other embodiments may include or be provided as another suitable household appliance.

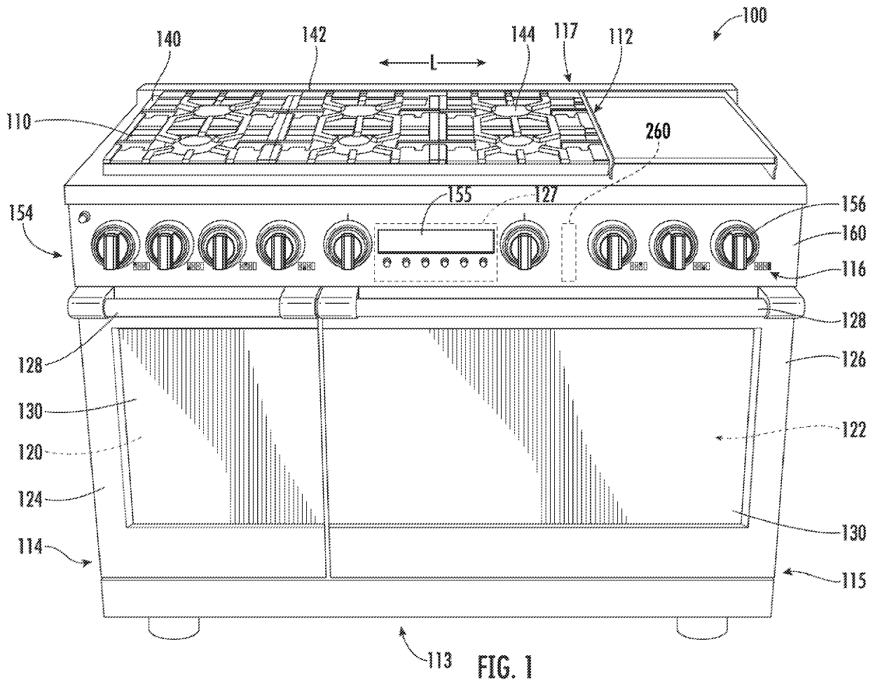

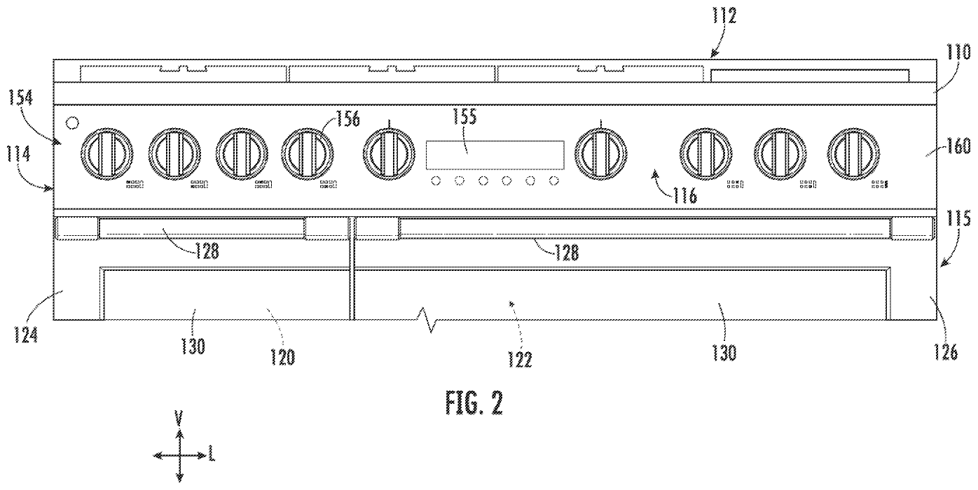

Turning now to the figures, FIG. 1 provides a front, perspective view of an oven or cooking appliance 100 as may be employed with the present disclosure. FIG. 2 provides a section, front view of a top portion or region of cooking appliance 100. Cooking appliance 100 includes an insulated cabinet housing or cabinet 110. As shown, cooking appliance 100 defines a vertical direction V, a lateral direction L, and a transverse direction T (e.g., at cabinet 110). The vertical direction V, lateral direction L, and transverse direction T are mutually perpendicular and form an orthogonal direction system.

Cabinet 110 generally configured for containing or supporting various components of appliance 100 and which may also define one or more internal chambers or compartments of appliance 100. In this regard, as used herein, the terms “cabinet,” “housing,” and the like are generally intended to refer to an outer frame or support structure for appliance 100 (e.g., including any suitable number, type, and configuration of support structures formed from any suitable materials, such as a system of elongated support members, a plurality of interconnected panels, or some combination thereof). It should be appreciated that cabinet 110 does not necessarily require an enclosure and may simply include open structure supporting various elements of appliance 100. By contrast, cabinet 110 may enclose some or all portions of an interior of cabinet 110. It should be appreciated that cabinet 110 may have any suitable size, shape, and configuration while remaining within the scope of the present subject matter.

As shown, cabinet 110 extends along the vertical direction V between a top portion 112 and a bottom portion 113; along the lateral direction L between a left side portion 114 and a right-side portion 115; and along the traverse direction T between a front portion 116 and a rear portion 117. In some embodiments, cabinet 110 defines multiple discrete cooking chambers, such as a first or left cooking chamber 120 and a second or right cooking chamber 122. Thus, cooking appliance 100 may generally referred to as a double oven range appliance. As will be understood by those skilled in the art, cooking appliance 100 is provided by way of example only, and the present subject matter may be used in any suitable appliance (e.g., a single-chamber cooking appliance, cooktop appliance without a cabinet). Thus, the example embodiments illustrated in the present figures are not intended to limit the present disclosure matter to any particular cooking chamber configuration or arrangement, except as otherwise indicated.

Left and right cooking chambers 120 and 122 are configured for the receipt of one or more food items to be cooked. Heating elements (not shown), such as electric resistance heating elements, gas burners, microwave heating elements, halogen heating elements, or suitable combinations thereof, are positioned within left cooking chamber 120 and right cooking chamber 122 for heating left cooking chamber 120 and right cooking chamber 122.

In the illustrated embodiments, cooking appliance 100 includes a left door 124 and a right door 126 movably (e.g., rotatably) attached to cabinet 110 in order to restrict or permit selective access to left cooking chamber 120 and right cooking chamber 122, respectively. Handles 128 are mounted to left and right doors 124 and 126 to assist a user with opening and closing doors 124 and 126 in order to access cooking chambers 120 and 122. As an example, a user can pull on the handle 128 mounted to left door 124 to open or close left door 124 and access left cooking chamber 120. Glass windowpanes 130 are provided for viewing the contents of left and right cooking chambers 120 and 122 when doors 124 and 126 are closed and also assist with insulating the cooking chambers 120 and 122.

Cooking appliance 100 includes a cooktop 140. Cooktop 140 may be positioned at or adjacent to the top portion 112 of cabinet 110. Thus, cooktop 140 is positioned above left and right cooking chambers 120 and 122. Cooktop 140 includes a top panel 142. By way of example, top panel 142 may be constructed of glass, ceramics, enameled steel, and combinations thereof. Cooktop 140 further includes a burner box 200, as will be described in more detail hereafter.

For cooking appliance 100, a utensil (not pictured) holding food or cooking liquids (e.g., oil, water, etc.) may be placed onto one or more of burner assemblies 144 (e.g., on a cooking grate). Burner assemblies 144 provide thermal energy to cooking utensils thereon. As shown in FIG. 1, burners assemblies 144 can be configured in various sizes so as to provide for the receipt of cooking utensils (e.g., pots, pans, etc.) of various sizes and configurations and to provide different heat inputs for such cooking utensils.

In some embodiments, user interface or control panel 154 is located within convenient reach of a user of the cooking appliance 100. For some example embodiments, user interface panel 154 includes a front panel 160 disposed on the front portion 116 of cabinet 110. As shown, front panel 160 may be mounted to cabinet 110. Moreover, user interface panel 154 may include one or more knobs 156 that are each associated with one of burner assemblies 144. Knobs 156 allow the user to activate each burner assembly and determine the amount of heat input provided by each burner assembly 144 to a cooking utensil located thereon. User interface panel 154 may also be provided with one or more graphical displays 155 that deliver certain information to the user such as, for example, whether a particular burner assembly is activated or the rate at which the burner assembly is set.

Although shown with knobs 156, it should be understood that knobs 156 and the configuration of cooking appliance 100 shown in FIGS. 1 and 2 is provided by way of example only. More specifically, user interface panel 154 may include various input components, such as one or more of a variety of touch-type controls, electrical, mechanical, or electro-mechanical input devices including rotary dials, push buttons, and touch pads. Optionally, the graphical display 155 may be provided as a touch screen interface configured to receive input commands from a user (e.g., via a capacitive touch panel). Moreover, the user interface panel 154 may include other display components, such as a digital or analog display device designed to provide operational feedback to a user.

Cooking appliance 100 may further equipped with a controller 127 to regulate operation of the cooking appliance 100. For example, controller 127 may regulate the operation of one or more portions of cooking appliance 100, such as the burner assemblies 144, user interface 154, etc. Controller 127 may be in communication (via, for example, a suitable wired or wireless connection) with user interface 154 (e.g., at graphical display 155 or knobs 156). In general, controller 127 may be operable to configure the cooking appliance 100 (and various components thereof) for cooking. Such configuration may be based on a plurality of cooking factors of a selected operating cycles, sensor feedback, etc. By way of example, controller 127 may include one or more memory devices and one or more processors, such as general or special purpose microprocessors operable to execute programming instructions or micro-control code associated with an operating cycle. The memory may represent random access memory such as DRAM or read only memory such as ROM or FLASH. In one embodiment, the processor executes programming instructions stored in memory. The memory may be a separate component from the processor or may be included onboard within the processor. The memory can store information accessible to processor, including instructions that can be executed by processor. Optionally, the instructions can be software or any set of instructions that when executed by the processor, cause the processor to perform operations. For certain embodiments, the instructions include a software package configured to operate appliance 100 and execute certain tasks.

Controller 127 may be positioned in a variety of locations throughout cooking appliance 100. As an example, one or more portions of controller 127 may be located within a user interface panel 154 of cooking appliance 100. In such an embodiment, input/output (“I/O”) signals may be routed between the control system and various operational components of cooking appliance 100 along wiring harnesses that may be routed through cabinet 110. Typically, controller 127 is in communication with user interface panel 154 through which a user may select various operational features and modes and monitor progress of cooking appliance 100. In example embodiments, user interface panel 154 may represent a general purpose I/O (“GPIO”) device or functional block.

Generally, controller 127 is in operative communication with burner assemblies 144, cooling fans 210, 212 or integrated gas burner 222. A temperature sensor 254 (e.g., thermistor, thermostat, etc.) may be located within cooking appliance 100 (e.g., on or within the burner box 200 or otherwise adjacent to an integrated gas burner 222). In some such embodiments, controller 127 is in operative communication with temperature sensor 254. During use, controller 127 may receive temperature data from the temperature sensor 254, such as in the form of one or more data signals corresponding to temperature at the temperature sensor 254, as would be understood.

Additionally or alternatively, cooking appliance 100 includes an altitude sensor 260, as shown in FIG. 1. In some embodiments, altitude sensor 260 is mounted to cabinet 110. During use, altitude sensor may detect an elevation or altitude of cooking appliance 100. For example, altitude sensor 260 may be an altimeter or an altitude meter. In some embodiments, altitude sensor 260 is a barometric pressure sensor, a pressor altimeter, or other suitable altitude sensors. Altitude sensor 260 may be in operative communication with controller 127 (e.g., to receive one or more data signals therefrom, which correspond to altitude, as would be understood).

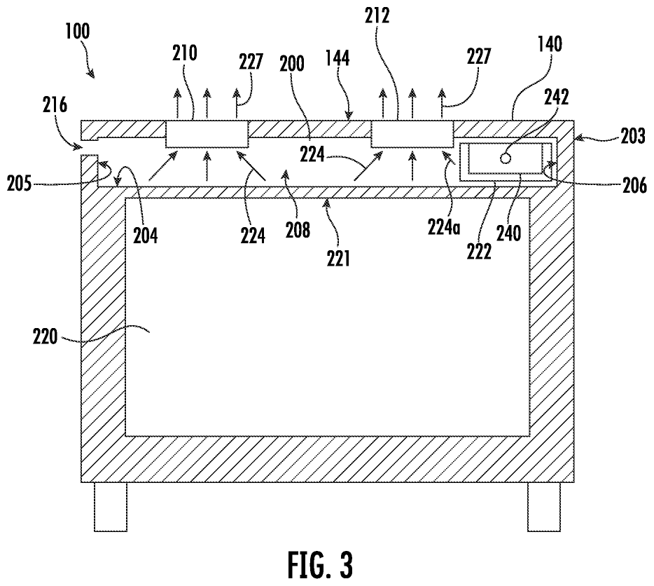

Turning generally to FIGS. 2 through 7, cooking appliance 100 includes burner box 200. Generally, burner box 200 encloses one or more integrated gas burners 222 (e.g., to manage air received at the integrated burner 222 or heat transmitted from the integrated burner 222 to the surrounding portions of the cooking appliance 100). During use of cooking appliance 100, burner box 200 may allow sufficient air flow to burner assemblies 144 or an integrated gas burner 222. Air flow (e.g., fluid flow 224 shown in FIG. 3) into and through burner box 200 may facilitate complete combustion of gas during activation of burner assemblies 144 or may aid in preventing overheating of cooking appliance 100 when burner assemblies 144 are activated.

As shown, burner box 200 includes a plurality of rigid (e.g., fixed, solid, or non-permeable) walls to enclose at least a portion of integrated gas burner 222. In the illustrated embodiments, burner box 200 includes a bottom wall 204, a front wall (e.g., at user interface panel 154), a rear wall 203, and a pair of opposing side walls 205, 206. Front wall 154 and rear wall 203 are spaced apart from one another along the transverse direction T and both the front wall 154 and rear wall 203 extend from bottom wall 204 along the vertical direction V. In addition, opposing side walls 205, 206 are spaced apart from one another along the lateral direction L, and each opposing side wall 205, 206 extends between front wall 154 and rear walls 203 along the transverse direction T.

As shown, burner box 200 defines a cavity 208 below cooktop 140. Burner box 200 also defines a ventilation opening 216. Ventilation opening 216 may extend through one or more of the rigid walls of burner box 200 and to the cavity 208. When assembled, ventilation opening 216 may be in fluid communication with the ambient environment (e.g., directly or through the portion of cabinet 110 surrounding burner box 200). In turn, at least a portion of ambient air outside cooking appliance 100 or a fluid flow (e.g., internal fluid flow 224 in FIG. 3) may pass through ventilation opening 216 to or from cavity 208.

In some embodiments, top panel 142 of cooktop 140 includes or is provided as a top wall of burner box 200; top panel 142 being separated from bottom wall 204 in the vertical direction V. In some embodiments, user interface panel 154 includes or is provided as front wall of burner box 200. Additionally or alternatively, the front wall of burner box 200 may be disposed behind user interface pane 154 in transverse direction T, and generally forward of other walls 203, 204, 205, 206 of burner box 200 in transverse direction T.

In certain embodiments, burner box 200 extends below burner assemblies 144 in vertical direction V. In some embodiments, burner box 200 is directly above internal chamber 220 (e.g., left cooking chamber 120 or right cooking chamber 122) relative to the vertical direction V. In some such embodiments, burner box 200 extends along the transverse direction T and in the lateral direction L across top oven panel 221 of internal chamber 220. For instance, bottom wall 204 of burner box 200 may extend in a plane with lateral direction L and transverse direction T directly above top oven panel 221, which may also extend in lateral direction L and transverse direction T.

As noted above, burner box 200 may surround or otherwise be in fluid communication with a corresponding integrated gas burner 222. In some embodiments, integrated gas burner 222 is located within cavity 208. Generally, integrated gas burner 222 includes an integrated enclosure 240 and a burner element 242. In some embodiments, cooktop 140 may include one or more integrated gas burners 222. In certain embodiments, integrated gas burner 222 is disposed beneath (e.g., at a lower height relative to the vertical direction V than) top panel 142.

Generally, integrated gas enclosure 240 of integrated gas burner 222 is located within burner box 200. Burner element 242 may be a gas burner element. During use, burner element 242 may be activated to provide heat to a portion of cooktop 140. Burner element 242 is located within integrated gas enclosure 240. In certain embodiments, integrated gas burner 222 includes or is provided as a griddle box, dual griddle, charbroiler, French top, teppan-yaki griddle, and other specialty gas burner. Burner element 242 of integrated gas burner 222 may be concealed underneath a component for cooking, such as a griddle, French top, or grill.

As shown in FIG. 3, burner box 200 is in fluid communication with at least one cooling fan (e.g., cooling fan 210 or cooling fan 212), or at least one burner assembly 144. In some embodiments, cooling fans 210, 212 are located proximal to burner box 200, such that cooling fan 210 or 212 can assist in generating a fluid flow (e.g., air flow) through burner box 200 (either into or out of cavity 208). For instance, cooling fans 210, 212 may be located along a wall or panel (e.g., top panel 142, rear wall 203, or side walls 205, 206), defining a hole or pathway for fluid to through burner box 200 and out of cooking appliance 100. In additional or alternative embodiments, burner box 200 may define a cooling fan cavity, and cooling fan 210, or cooling fan 212 may be attached to burner box 200, at the cooling fan cavity. For the embodiments described herein, cooling fans 210, 212 generally move air or fluid from burner box 200 to the ambient environment outside cooking appliance 100.

Cooling fans 210, 212 may be any motorized fan that, during use, may move fluid, such as air, from one location to another. For example, as shown by fluid flow arrows 224 and 227, cooling fans 210, 212 may aid in directing or motivating air from cavity 208, through cooling fans 210, 212, and out of cooking appliance 100. In some embodiments, cooling fans 210, 212 are provided as or include radial fans that each include a motor attached to a set of fins such that, during use, the motor rotates the set of fins about an axis, motivating fluid, such as air, from one location to another. In some embodiments, cooling fans 210, 212 are tangential fans that direct air over an internal impeller. Other fans may be used as known in the art, to draw fluid flow from burner box 200 across cooling fans 210, 212 and into the ambient environment external to cooking appliance 100.

Though two fans, cooling fans 210, 212 are shown in FIGS. 3 through 5, embodiments may have more cooling fans or fewer cooling fans than those depicted in different embodiments. Cooling fans 210, 212 may serve similar purposes for purposes described herein, and cooling fan 210 may be interchanged with cooling fan 212 in the remaining description.

FIG. 3 depicts cooking appliance 100 during a default operation.

Generally, controller 127 directs the default operation. At least one burner assembly 144 may be activated during the default operation (e.g., by controller 127 receiving a request to activate burner assembly 144 and controller 127 prompting activation of burner assembly 144 in response to receiving the user activation request with regards to burner assembly 144). Integrated gas burner 222 may be inactivated or turned off during the default operation. During default operation, cooling fans 210, 212 direct internal fluid flow 224 (depicted by arrows in FIGS. 3 through 5) across cooling fans 210, 212, and out of cooking appliance 100 via downstream fluid flow 226 (also depicted by arrows in FIGS. 3 through 5).

During default operation, cooling fans 210, 212 may be activated or otherwise directed to rotate (e.g., at a first or default rotational speed) and motivate ambient air (e.g., from outside burner box 200 or cooking appliance 100, generally), therethrough, directing air through cooling fans 210, 212 to the ambient environment (e.g., above fan 210 or 212). This process may create a negative pressure in burner box 200, and air may be motivated to enter burner box 200 through ventilation opening 216 (e.g., in order to reach equilibrium). In FIG. 3, air is drawn away from the inactive integrated gas burner 222 towards cooling fans 210, 212 (e.g., as an internal fluid flow, as shown by arrows 224a). Air flow may then be directed through cooling fans 210, 212 and out of cooking appliance 100 as an external fluid flow (e.g., illustrated as arrows 227). The fluid flow 224 (e.g., at 224a) may generate a negative pressure or lack of fluid around integrated gas burner 222.

In some embodiments, cooling fan 210 operates in the default operation as described herein to regulate the temperature of burner box 200 during operation of burner assemblies 144. Cooling fans 210, 212 may operate (i.e., rotate to motivate air) during operation of burner assemblies 144 or integrated gas burner 222. In additional or alternative embodiments, cooling fans 210, 212 can be selectively operated in accordance with a cooling program controlled by the controller 127. For example, the cooling fans 210, 212 may operate when the burner box 200 exceeds a pre-set temperature or may operate when a burner assembly 144 is activated or turned on.

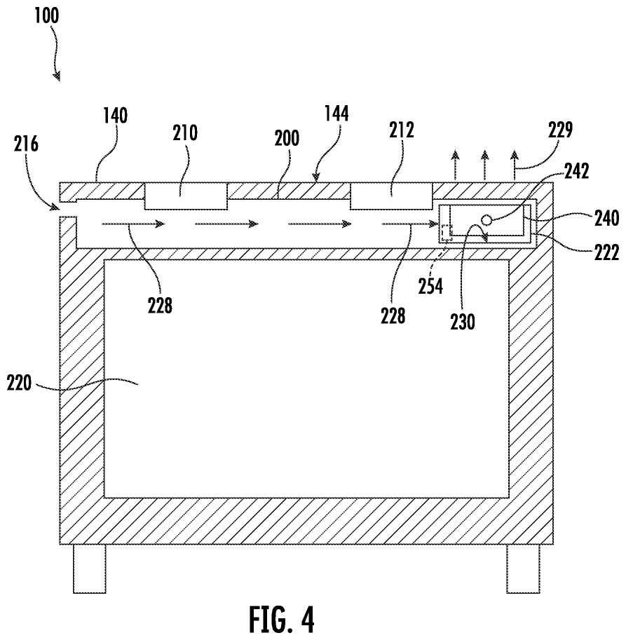

Generally, controller 127 may direct operations of cooling fan 210 during initial ignition of integrated gas burner 222 or during the cooking operation. For instance, as shown in FIG. 4, during initial activation (e.g., ignition) stages of integrated gas burner 222, cooling fan 210 may be directed to a limited speed setting (e.g., wherein rotation of the cooling fan 210 is halted, reduced, or fan 210 is otherwise directed to rotational speed below that of the default speed setting). The limited speed setting may be maintained, for instance, for a predetermined time period. In the limited speed setting, air may be permitted to flow towards integrated gas burner in an internal operation fluid flow 228. Thus, as the integrated gas burner 222 is turned on or warming up, air flow 228 may be directed from ventilation opening 216 toward integrated gas burner 222 and out through integrated gas burner 222 (e.g., via external operation fluid flow 229).

Advantageously, directing fluid flow 228 to integrated gas burner 222 during the cooking operation may reduce or negate negative pressure formed during the default operation, which may, in turn, allow flames from activated integrated gas burner 222 to remain stable when activated. Temperature of integrated burner box 200 may be allowed to increase during the predetermined time period. This may aid in bringing integrated gas burner 222 to a desired temperature (e.g., as set by the user using controls 156 or control panel 154).

During use, controller 127 may initiate a cooking operation. In some embodiments, the cooking operation includes the controller 127 receiving a user activation request for integrated gas burner 222. For example, a user may do this using controls such as knobs 156 or control panel 154. The cooking operation may further include controller 127 prompting activation of integrated gas burner 222 in response to receiving the user activation request.

In some embodiments, directing limited-speed operation of cooling fan 210 includes setting a maximum rotational speed threshold. The maximum rotational speed threshold may be greater than zero. For example, directing limited-speed operation of cooling fan 210 includes controller 127 directing cooling fan 210 to rotate below a maximum rotational speed threshold. The maximum rotational speed threshold may be reduced in comparison to the rotational speed cooling fan 210 rotates at during the default operation. In some embodiments, cooling fan 210 may operate at a limited speed setting that does not exceed the maximum rotational speed threshold. Fluid flow 228, 229 when limited-speed operation includes a maximum rotational speed threshold greater than zero would still be similar to that depicted in FIG. 4 for the majority of air flow through burner box 200.

In some embodiments, the predetermined time period is a time period initiated with activation of integrated gas burner 222. During the predetermined time period, limited-speed operation of cooling fan 210 takes place. When controller 127 receives user activation of integrated gas burner 222, the predetermined time period starts, and limited speed operation also initiates. Additionally or alternatively, controller 127 may track the beginning of predetermined time period, for example, by starting a timer upon activation of integrated gas burner 222. Controller 127 may further store the predetermined time period value and may end limited-speed operation of cooling fan 210 upon expiration of predetermined time period.

Optionally, the predetermined time period may include a first sub-period and a second sub-period. The first sub-period may include halting cooling fan 210 operation. The second sub-period may include directing cooling fan 210 to rotate at a limited speed setting including a maximum rotational speed threshold greater than zero and less than a default operation rotational speed. In some embodiments, second sub-period may follow first sub-period. Advantageously, halting cooling fan 210 operation during the first sub-period may allow integrated gas burner 222 to have no fluid flow interruption when first turned on, with the second sub-period providing some, but still minimal fluid flow interruption as integrated gas burner 222 warms up. Integrated gas burner 222 may be most susceptible to flame disruption during first sub-period, when integrated gas burner 222 is colder than during second sub-period, when integrated gas burner 222 has warmed by being on during first sub-period. As integrated gas burner 222 remains on, surrounding surfaces (e.g., bottom of integrated gas burner 230) gain heat from the burning of gas by integrated gas burner 222.

In some embodiments the predetermined period may be between about 3 and about 25 minutes. In certain embodiments, the predetermined time period may be between about 5 minutes and about 15 minutes. In certain embodiments, the time period may be about 10 minutes.

In certain embodiments, directing limited-speed operation of cooling fan 210 for the predetermined time period is based on a received altitude signal. For example, in embodiments where altitude of cooking appliance 100 may be monitored, the predetermined time period for running the limited-speed operation of the cooling fan 210 may be adjusted for altitude. For instance, the predetermined time period may be extended at higher altitudes and shortened for lower altitudes. As would be understood, if altitude sensor 260 senses cooking appliance 100 is below a preset altitude, or controller 127 receives altitude data from altitude sensor 260 indicating cooking appliance 100 is below a preset altitude, controller 127 may direct limited-speed operation of cooling fans 210, 212 for a smaller predetermined time period. If altitude sensor 260 instead senses cooking appliance 100 is at or above a preset altitude, or controller 127 receives altitude data from altitude sensor 260 indicating cooking appliance 100 is at or above a preset altitude, controller 127 may direct limited-speed operation of cooling fans 210, 212 for a longer predetermined time period. Optionally, the cooking operation may include determining the received altitude signal is below a preset elevation threshold and setting the predetermined time period to zero in response to determining the received altitude signal is below the preset elevation threshold. Preset altitude values may be set (e.g., automatically) within controller 127 in some embodiments. In certain embodiments, preset altitude values may be manually preset by a user.

Additionally or alternatively, the predetermined time period may be based on a temperature reading from temperature sensor 254. For example, controller 127 may initiate the cooking operation (e.g., upon receiving user activation request for the integrated gas burner 222) and may continue to direct the cooking operation, including directing limited-speed operation of cooling fans 210, 212, until receipt of a temperature from temperature sensor 254 that exceeds a predetermined temperature value. The predetermined temperature value received from temperature sensor 254 may generally indicate that the area surrounding integrated gas burner 222 is at a hot enough temperature to draw sufficient air flow to regulate the flame of activated integrated gas burner 222 if cooling fans 210, 212 are operated under the default operation. Upon exceeding the predetermined temperature value, controller 127 may halt or otherwise end of the predetermined time period.

Optionally, temperature sensor 254 may monitor temperature of burner box 200 or an area surrounding to or within integrated gas burner 222 and may send a temperature signal to controller 127 with the initiation of the cooking operation at set time intervals. In some embodiments, such temperature readings may continue to be sent until the predetermined temperature value is received, until controller 127 completes the cooking operation, or until controller 127 resumes the default operation.

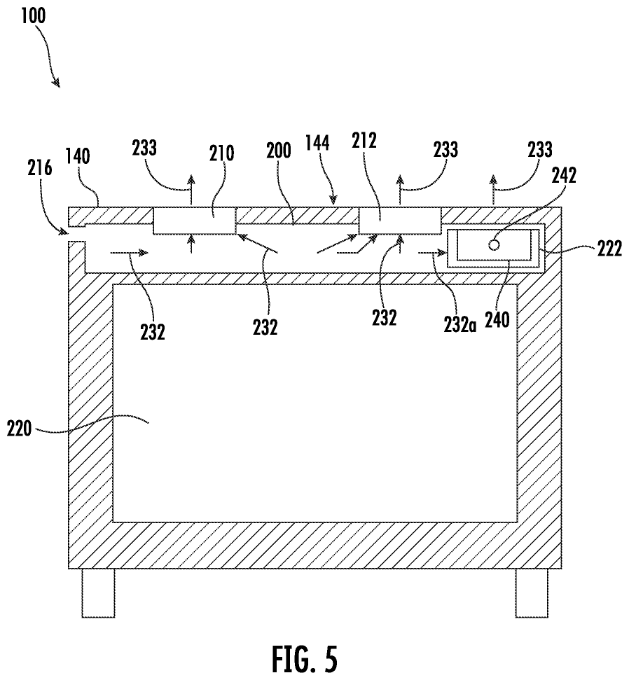

Turning now to FIG. 5, following the initial stages of a cooking operation (e.g., after expiration of the predetermined time period), rotational speed of the fan 210 (and thus the speed of air through burner box 200) may be modified. FIG. 5, in particular, depicts preheated fluid flow 232, 233 through the burner box 200 after expiration of the predetermined time period. In some embodiments, controller 127 directs the fan 210 to an increased-speed operation in response to expiration of the predetermined time period. Increased-speed operation may include constant speed while integrated gas burner 222 or another burner assembly (e.g., burner assembly 144) is activated on the cooktop 140. As such, a preheated fluid flow 232 may move from outside cooking appliance 100 to inside burner box 200. Subsequently, a portion of the air in preheated fluid flow 232 may travel to cooling fans 210, 212 while another portion of air (e.g., preheated fluid flow 232a) flows to integrated gas burner 222. Preheated external fluid flow 233 may then proceed through cooling fans 210, 212 and out of cooktop 140. Notably, integrated gas burner 222 may be at a sufficient temperature to draw air toward it even with cooling fans 210, 212 operating at an increased-speed operation following the predetermined time period.

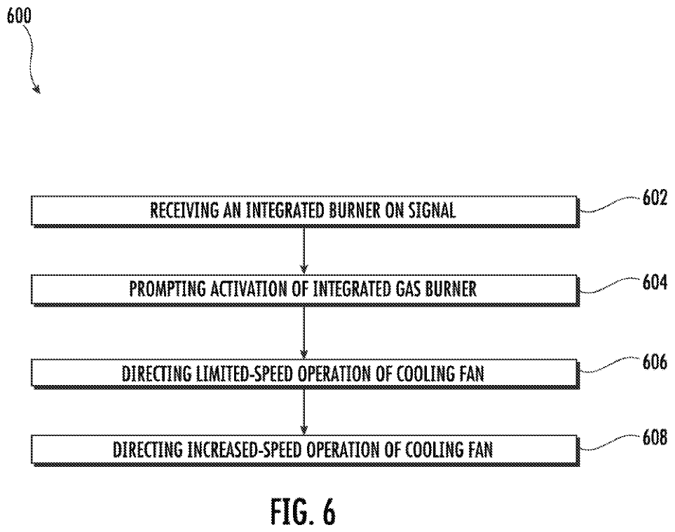

Referring now to FIG. 6, a flow diagram of a method 600 of initiating a cooking operation for a cooking appliance 100 in accordance with an exemplary aspect of the present disclosure is provided. The method 600 of FIG. 6 may be utilized to operate one or more of the exemplary cooking appliances described above with reference to FIGS. 1 through 5. Accordingly, it will be appreciated that the method 600 may generally be utilized to initiate a cooking operation including operating a cooking appliance that includes directing a limited-speed operation of the cooling fan over a predetermined time period. However, in other exemplary aspects, the method 600 may additionally or alternatively be utilized to operate any other suitable cooking appliance with at least one cooking fan.

As is depicted, the method 600 includes at step 602 receiving a user activation request for an integrated gas burner. This includes a user using controls to direct the controller to activate an integrated gas burner, as described above. The method further includes at step 604 prompting activation of the integrated gas burner. Step 604 may be performed in response to receiving the user activation request for the integrated gas burner (e.g., from an input or knob of the user interface).

The method 600 includes at step 606 directing limited-speed operation of the cooling fan. Limited-speed operation of the cooling fan may include operating the cooling fan at a steady or variable speed at or below the maximum cooling fan speed, the maximum cooling fan speed much slower than the cooling fan speed of the cooling fan during the default operation described herein. In some embodiments, step 606 is in response to the activation of the integrated gas burner. In some embodiments, step 606 includes turning the cooling fan to a limited-speed setting. For example, turning the fan to a limited-speed setting may include setting the cooling fan to a set speed lower than the speed of the fan during the default operation or halting the cooling fan's operation. In certain embodiments, step 606 includes setting a maximum rotational speed threshold. The maximum rotational speed threshold may be greater than zero. Hence, the cooling fan may be directed to run at a rotational speed that is no greater than the maximum rotational speed, while also not halting the rotation of the cooling fan.

In some embodiments, step 606 is performed over a predetermined time period. As previously stated, the predetermined time period may include a first sub-period and a second sub-period. During the first sub-period, step 606 may include halting the operation of the cooling fan. During the second sub-period, step 606 may include directing the cooling fan to rotate at a limited speed setting, the limited speed setting comprising a maximum rotational speed threshold greater than 0 and less than a default operation rotational speed. Additionally or alternatively, the predetermined time period may be initiated with activation of the integrated gas burner (e.g., step 604).

In some embodiments, the method 600 includes receiving an altitude signal from an altitude sensor (as described herein). Such receipt of the altitude signal generally be received prior to directing limited-speed operation of the cooling fan. If the altitude signal received is identified as an altitude signal above a preset-elevation, limited-speed operation may be directed, such as for a predetermined amount of time, as described herein. Generally, the altitude signal should be received before the end of step 606, so that directing limited-speed operation may be directed in accordance with the altitude reading from the altitude sensor.

The method 600 includes at step 608 directing increased-speed operation of the cooling fan. For example, directing increased-speed operation may include directing the default operation of the cooling fan, including directing the cooling fans to a default speed setting to regulate the temperature within the burner box. The default operation may be additionally performed in embodiments as described herein. Step 608 may be performed in response to expiration of the predetermined time period.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance having a lateral, vertical, and transverse direction, the cooking appliance comprising:
a burner box;
an integrated gas burner in fluid communication with the burner box;
a cooling fan in fluid communication with the burner box and the integrated gas burner; and
a controller, the controller in operative communication with the integrated gas burner and the cooling fan, the controller configured to initiate a cooking operation comprising
receiving a user activation request for the integrated gas burner,
prompting activation of the integrated gas burner in response to receiving the user activation request,
directing, in response to prompting activation of the integrated gas burner, limited-speed operation of the cooling fan over a predetermined time period, and
directing, in response to expiration of the predetermined time period, increased-speed operation of the cooling fan.

2. The cooking appliance of claim 1, wherein directing limited-speed operation of the cooling fan comprises halting rotation of the cooling fan over the predetermined time period.

3. The cooking appliance of claim 1, wherein directing limited-speed operation of the cooling fan comprises a maximum rotational speed threshold, and
wherein the maximum rotational speed threshold is greater than 0.

4. The cooking appliance of claim 1, wherein the predetermined time period comprises a first sub-period and a second sub-period, the first sub-period comprising halting the operation of the cooling fan and the second sub-period comprising directing the cooling fan to rotate at a limited-speed setting, the limited-speed setting comprising a maximum rotational speed threshold greater than 0 and less than a default operation rotational speed.

5. The cooking appliance of claim 1, wherein the predetermined time period is initiated with the activation of the integrated gas burner.

6. The cooking appliance of claim 1, wherein the cooking appliance further comprises an altitude sensor in operative communication with the controller, and
wherein the controller is further configured to receive altitude signals from the altitude sensor to determine an elevation of the cooking appliance.
wherein the cooking operation further comprises receiving an altitude signal from the altitude sensor, and
wherein directing limited-speed operation is based on the received altitude signal.

7. The cooking appliance of claim 6, wherein the cooking operation further comprises
determining the received altitude signal is below a preset elevation threshold, and
setting the predetermined time period to zero in response to determining the received altitude signal is below the preset elevation threshold.

8. The cooking appliance of claim 1, wherein the integrated gas burner comprises an integrated enclosure and a burner element located within the integrated enclosure.

9. The cooking appliance of claim 1, wherein the predetermined time period is between about 5 minutes and about 15 minutes.

10. A method of operating a cooking appliance, the method comprising the steps of:
receiving a user activation request for an integrated gas burner,
prompting activation of the integrated gas burner in response to receiving the user activation request,
directing, in response to prompting activation of the integrated gas burner, limited-speed operation of a cooling fan over a predetermined time period, and
directing, in response to expiration of the predetermined time period, increased-speed operation of the cooling fan,
wherein the cooling fan is in fluid communication with a burner box, the burner box in fluid communication with the integrated gas burner, and
wherein the cooling fan is in fluid communication with the burner box and the integrated gas burner.

11. The method of claim 10, wherein the step of directing limited-speed operation of the cooling fan comprises halting rotation of the cooling fan over the predetermined time period.

12. The method of claim 10, wherein the step of directing limited-speed operation of the cooling fan for the predetermined time period further comprises turning the cooling fan to a limited-speed setting.

13. The method of claim 10, wherein the step of directing limited-speed operation of the cooling fan comprises a maximum rotational speed threshold, and
wherein the maximum rotational speed threshold is greater than zero.

14. The method of claim 10, wherein the predetermined time period comprises a first sub-period and a second sub-period, the first sub-period comprising halting the operation of the cooling fan and the second sub-period comprising directing the cooling fan to rotate at a limited-speed setting, the limited-speed setting comprising a maximum rotational speed threshold greater than 0 and less than a default operational rotational speed.

15. The method of claim 10, wherein the predetermined time period is initiated with the activation of the integrated gas burner.

16. The method of claim 10 wherein the step of directing limited-speed operation of the cooling fan further comprises receiving an altitude signal from an altitude sensor, and
directing limited-speed operation is based on the received altitude signal,
wherein the altitude signal is in operative communication with a controller of the cooking appliance.

17. The method of claim 16, wherein the step of directing limited-speed operation of the cooling fan further comprises determining the received altitude signal is below a preset elevation threshold, and
setting the predetermined time period to zero in response to determining the received altitude signal is below the preset elevation threshold.

18. The method of claim 10, wherein the integrated gas burner comprises an integrated enclosure and a burner element located within the integrated enclosure.
